(19) United States
(12) Patent Application Publication
(10) Pub. No.: US 2022/0396117 A1
(43) Pub. Date: Dec. 15, 2022

(54) Cooling System for Vehicle

(71) Applicants: Hyundai Motor Company, Seoul (KR); Kia Corporation, Seoul (KR)

(72) Inventors: Yeonho Kim, Seoul (KR); Jungha Park, Gunpo-si (KR); Jeawan Kim, Gwangmyeong-si (KR); Jae Yeon Kim, Hwaseong-si (KR); Myunghwan Kim, Suwon-si (KR)

(21) Appl. No.: 17/643,230

(22) Filed: Dec. 8, 2021

(30) Foreign Application Priority Data
Jun. 11, 2021 (KR) 10-2021-0075822

(51) Int. Cl. B60H 1/00; B60H 1/32

(52) U.S. Cl. CPC B60H 1/00278; B60H 1/00392; B60H 1/323; B60H 1/32284; B60H 2001/00307

(57) ABSTRACT

The present disclosure provides a cooling system for a vehicle including: a first cooling device including a first radiator and a first water pump connected by a first coolant line; a second cooling device including a second radiator and a second water pump connected by a second coolant line; a battery module provided in the second coolant line; a coolant connection line selectively connected to the first coolant line through a first valve; a battery module provided in the second coolant line; an autonomous driving controller provided on the coolant connection line; and at least one chiller connected to each of the first coolant line and the second coolant line. Temperatures of the battery module and the autonomous driving controller may be adjusted by the first coolant or the second coolant passing through the at least one chiller.

### CROSS-REFERENCE TO RELATED APPLICATIONS

This application claims priority to and the benefit of Korean Patent Application No. 10-2021-0075822 filed in the Korean Intellectual Property Office on Jun. 11, 2021, the entire contents of which are incorporated herein by reference.

### TECHNICAL FIELD

The present disclosure relates to a cooling system for a vehicle, and more particularly, a cooling system for a vehicle for efficiently cooling electrical components, a battery module, and an autonomous driving controller by linking a cooling device in which coolant is circulated and an air conditioning device in which refrigerant is circulated in a vehicle in which autonomous driving is available.

### BACKGROUND

Generally, a vehicle is equipped with an air conditioning system for adjusting a room temperature of the vehicle.

Such an air conditioning system which maintains a comfortable interior environment by keeping a temperature of the interior of the automobile at an appropriate temperature regardless of a temperature change of the outside is configured to heat or cool the interior of the automobile by heat-exchange by an evaporator while the refrigerant discharged by driving a compressor passes through a condenser, a receiver drier, an expansion valve, and the evaporator and circulates to the compressor again.

That is, in the air conditioning system, high-temperature and high-pressure gaseous refrigerant compressed by the compressor is condensed through the condenser and thereafter, evaporated in the evaporator through the receiver drier and the expansion valve to lower a temperature and humidity of the interior in a summer cooling mode.

On the other hand, recently, there has been a demand for development of a vehicle capable of autonomous driving, and a radar, a Lidar, a global positioning system (GPS), etc., various sensors, and an autonomous driving controller controlling the same, which are required for the autonomous driving are mounted on the vehicle.

However, in the vehicle capable of the autonomous driving, as a separate cooling device cooling an autonomous driving controller having a relatively large heat dissipation amount is required together with a cooling device cooling an engine or a motor, and the electrical components, a cooling device preventing heat dissipation of the battery module including a fuel cell, and an air conditioning system cooling or heating a room of the vehicle, there is a disadvantage in that cost increases, and it is difficult to secure a space for being equipped with the cooling system inside a narrow vehicle.

Further, there is also a disadvantage in that a size and a weight of a cooling module mounted on the vehicle increase, and a layout of connection pipes for supplying the refrigerant or the coolant to the cooling device, the air conditioning device, and the autonomous driving controller cooling device in a narrow space is complicated.

The above information disclosed in this Background section is only for enhancement of understanding of the background of the disclosure, and therefore it may contain information that does not form the prior art that is already known in this country to a person of ordinary skill in the art.

The above information disclosed in this Background section is only for enhancement of understanding of the background of the disclosure, and therefore it may contain information that does not form the prior art that is already known in this country to a person of ordinary skill in the art.

### SUMMARY

Accordingly, the present disclosure is contrived to solve the problem and the present disclosure has been made in an effort to provide a cooling system for a vehicle for efficiently cooling electrical components, a battery module, and an autonomous driving controller by linking a cooling device in which coolant is circulated and an air-conditioning device in which refrigerant is circulated in a vehicle in which autonomous driving is available.

An exemplary embodiment of the present disclosure provides a cooling system for a vehicle, including: a first cooling device including a first radiator and a first water pump connected by a first coolant line, and circulating first coolant in the first coolant line to cool at least one electrical component; a second cooling device including a second radiator and a second water pump connected by a second coolant line, and circulating second coolant in the second coolant line; a battery module provided in the second coolant line; an autonomous driving controller cooling device including a coolant connection line selectively connected to the first coolant line through a first value, in which the first coolant flows, and an autonomous driving controller provided on the coolant connection line; and at least one chiller connected to each of the second coolant line and the coolant connection line, and connected to an air conditioning device, and heat-exchanging the first coolant or the second coolant which is selectively introduced with refrigerant supplied from the air conditioning device to adjust a temperature of the first coolant or the second coolant, in which temperatures of the battery module and the autonomous driving controller may be adjusted by the first coolant or the second coolant passing through the at least one chiller.

The at least one chiller may include a first chiller connected to the air conditioning device through a refrigerant connection line, and a second chiller connected to the air conditioning device through a refrigerant line.

The first chiller may be disposed in parallel to the second chiller through the refrigerant connection line based on the refrigerant line.

A first expansion valve may be provided on the refrigerant connection line, and a second expansion valve may be provided on the refrigerant line connected to the second chiller.

A third water pump may be provided on the coolant connection line.

The at least one chiller may include a first heat dissipation unit connected to the second coolant line, a second heat dissipation unit connected to the coolant connection line, and a partition partitioning the first heat dissipation unit and the second heat dissipation unit inside the chiller so as to prevent the first and second coolant supplied through the second coolant line and the coolant connection line, respectively from being mixed, and passing the refrigerant.

The first heat dissipation unit and the second heat dissipation unit may be integrally configured, and an expansion valve may be provided on the refrigerant line connected to the at least one chiller.

The second coolant passing through the first heat dissipation unit may be supplied to the battery module along the second coolant line, and the first coolant passing through the second heat dissipation unit may be supplied to the autonomous driving controller along the coolant connection line.

The first valve may be a 4-way valve.

The first radiator and the second radiator may be formed in an integrated form partitioned to prevent the first and second coolant from being mixed.

The first cooling device may further include a first branch line connected to the first coolant line between the first radiator and the first water pump through a second valve provided on the first coolant line between the first radiator and the first water pump.

Another exemplary embodiment of the present disclosure provides a cooling system for a vehicle, including: a first cooling device including a first radiator and a first water pump connected by a first coolant line, and circulating first coolant in the first coolant line to cool at least one electrical component; a second cooling device including a second radiator and a second water pump connected by a second coolant line, and circulating second coolant in the second coolant line; a coolant connection line selectively connected to the first coolant line through a first valve, in which the first coolant flows; a battery module provided in the second coolant line; an autonomous driving controller provided on the coolant connection line; at least one chiller connected to each of the second coolant line and the coolant connection line, and connected to an air conditioning device, and heat-exchanging the first coolant or the second coolant which is selectively introduced with refrigerant supplied from the air conditioning device to adjust a temperature of the first coolant or the second coolant; a first branch line connected to the first coolant line between the first radiator and the first water pump through a second valve provided on the first coolant line between the first radiator and the first water pump; a second branch line selectively disconnecting the coolant connection line and the first coolant line according to a selective operation of the first valve; and a third branch line selectively connecting the coolant connection line so that the coolant connection line forms a closed circuit independent from the first cooling device according to the selective operation of the first valve, in which temperatures of the battery module and the autonomous driving controller may be adjusted by coolant cooled while passing through the at least one chiller.

One of the second branch line may be connected to the first valve, and the other end of the second branch line may be connected to a location where the first coolant line and the coolant connection line are connected between the at least one electrical component and the third branch line.

A third water pumps may be provided on the coolant connection line.

One end of the third branch line may be connected to the coolant connection line between the first valve and the third water pump, and the other end of the third branch line may be connected to the coolant connection line between the second branch line and the autonomous driving controller.

The at least one chiller may include a first chiller connected to the air conditioning device through a refrigerant connection line, and a second chiller connected to the air conditioning device through a refrigerant line.

The first chiller may be disposed in parallel to the second chiller through the refrigerant connection line based on the refrigerant line.

A first expansion valve may be provided on the refrigerant connection line, and a second expansion valve may be provided on the refrigerant line connected to the second chiller.

The at least one chiller may include a first heat dissipation unit connected to the second coolant line, a second heat dissipation unit connected to the coolant connection line, and a partition partitioning the first heat dissipation unit and the second heat dissipation unit inside the chiller so as to prevent the first and second coolant supplied through the second coolant line and the coolant connection line, respectively from being mixed, and passing the refrigerant.

The first heat dissipation unit and the second heat dissipation unit may be integrally configured, and an expansion valve may be provided on the refrigerant line connected to the at least one chiller.

The coolant passing through the first heat dissipation unit may be supplied to the battery module along the second coolant line, and the coolant passing through the second heat dissipation unit may be supplied to the autonomous driving controller along the coolant connection line.

The first radiator and the second radiator may be formed in an integrated form partitioned to prevent the first and second coolant from being mixed.

According to the cooling system for a vehicle according to the exemplary embodiment of the present disclosure as described above, an autonomous driving controller is efficiently cooled by using coolant by linking a cooling device in which coolant is circulated and an air-conditioning device in which refrigerant is circulated in a vehicle in which autonomous driving is available to simplify an entire system and simplify a layout of pipes.

Further, according to the present disclosure, at least one chiller is applied, which lowers a temperature of the coolant by using refrigerant circulated in the air conditioning device to more efficiently cool a battery module and the autonomous driving controller by using low-temperature coolant.

Further, according to the present disclosure, the battery module or the autonomous driving controller is efficiently cooled according to a temperature, a driving condition, or an external environment of each of the battery module and the autonomous driving controller to enhance durability and performance of each of components.

Furthermore, according to the present disclosure, overall merchantability of the vehicle, and customer satisfaction can be enhanced.

### BRIEF DESCRIPTION OF THE DRAWINGS

FIG. 1 is a block diagram of a cooling system for a vehicle according to a first exemplary embodiment of the present disclosure.

FIG. 2 is a block diagram of a cooling system for a vehicle according to a second exemplary embodiment of the present disclosure.

FIG. 3 is a block diagram of a cooling system for a vehicle according to a third exemplary embodiment of the present disclosure.

FIG. 4 is an operation state view depending on a third cooling mode in a cooling system for a vehicle according to a fourth exemplary embodiment of the present disclosure.

### DETAILED DESCRIPTION

An exemplary embodiment of the present disclosure will hereinafter be described in detail with reference to the accompanying drawings.

Prior to this, configurations illustrated in the exemplary embodiments and drawings disclosed in the present specification are only the most preferred embodiment of the present disclosure and do not represent all of the technical spirit of the present disclosure, and thus it is to be understood that various equivalents and modified examples, which may replace the configurations, are possible when filing the present application.

The drawings and description are to be regarded as illustrative in nature and not restrictive, and like reference numerals designate like elements throughout the specification.

Since size and thickness of each component illustrated in the drawings are arbitrarily represented for convenience in explanation, the present disclosure is not particularly limited to the illustrated size and thickness of each component and the thickness is enlarged and illustrated in order to clearly express various parts and areas.

In addition, throughout the specification, unless explicitly described to the contrary, the word “comprise”, and variations such as “comprises” or “comprising”, will be understood to imply the inclusion of stated elements but not the exclusion of any other elements.

In addition, the terms “unit”, “means”, “part”, and “member”, which are described in the specification, mean a unit of a comprehensive configuration that performs at least one function or operation.

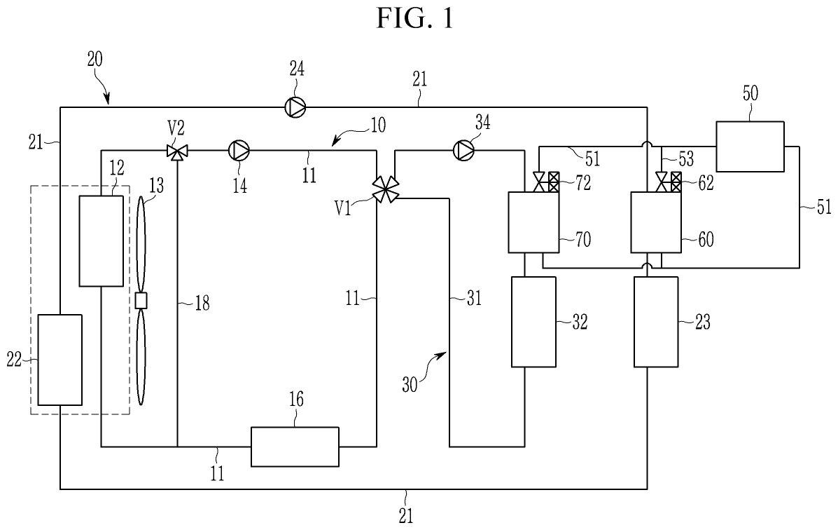

FIG. 1 is a block diagram of a cooling system for a vehicle according to a first exemplary embodiment of the present disclosure.

Referring to FIG. 1, the cooling system for a vehicle according to the first exemplary embodiment of the present disclosure is applied to a vehicle capable of autonomous driving.

The vehicle includes a radar, a Lidar, a global positioning system (GPS), and various sensors for the autonomous driving, and includes an autonomous driving controller 32 for controlling the equipments.

Further, the vehicle includes a first cooling device 10, a second cooling device 20, and an autonomous driving controller cooling device 30 cooling at least one electrical component 16, or a battery module 23, or an autonomous driving controller 32 by using first and second coolant, and an air conditioning device 50 cooling or heating a vehicle interior.

That is, referring to FIG. 1, in the first exemplary embodiment of the present disclosure, the cooling system includes the first cooling device 10 for cooling the electrical component 16, the second cooling device 20 for cooling the battery module 23, the autonomous driving controller cooling device 30 for cooling the autonomous driving controller 32, at least chiller, and the air conditioning device 50.

First, the first cooling device 10 includes a first radiator 12 and a first water pump 14 connected through a first coolant line 11.

The first cooling device 10 circulates the first coolant to the first coolant line 11 by operating the first water pump 14 so as to cool the electrical component 16.

The first radiator 12 is disposed in front of the vehicle and a cooling fan 13 is provided in the rear of the vehicle to cool the coolant through the operation of the cooling fan 13 and heat exchange with outside air.

Here, the electrical component 16 may include a power control device, an inverter, or an on board charger (OBC). The power control device and the inverter may dissipate heat during driving and the OBC may dissipate heat when the battery module 23 is charged.

The first cooling device 10 configured as such circulates the coolant cooled by the first radiator 12 along the first coolant line 11 by operating the first water pump 14 to cool the electrical component 16 not to be overheated.

In the first exemplary embodiment of the present disclosure, the second cooling device 20 includes a second radiator 22 and a second water pump 24 connected through a second coolant line 21 and circulates the second coolant to the second coolant line 21.

The second cooling device 20 may selectively supply the second coolant cooled by the second radiator 22 to the battery module 23.

The second radiator 22 is disposed on the same line as the first radiator 12 based on the front and rear direction of the vehicle, and heat-exchange the second coolant introduced into the inside with the outside air.

Here, the first radiator 12 and the second radiator 22 may be formed by an integrated form partitioned so as to prevent the first coolant and the second coolant from being mixed.

The second cooling device 20 configured as such may circulate the second coolant cooled by the second radiator 22 along the second coolant line 21 by operating the second water pump 26.

Meanwhile, in the first exemplary embodiment of the present disclosure, it is described as an exemplary embodiment that each of the first and second radiators 12 and 22 are provided and integrally formed, but the present disclosure is not limited thereto, and the exemplary embodiment may be applied to only one radiator of the first and second radiators 12 and 22 and each of the first and second cooling devices 10 and 20 may be connected to one radiator.

In the first exemplary embodiment of the present disclosure, the battery module 23 is provided in the second coolant line 2.

The battery module 23 may be cooled by the second coolant circulated in the second coolant line 21 by operating the second water pump 24.

That is, the battery module 23 may supply electrical power to the electrical component 16, and may be formed into a water-cooled type to be cooled by the coolant flowing along the second coolant line 21.

The autonomous driving controller cooling device 30 may include a coolant connection line 31 and the autonomous driving controller 32.

First, the coolant connection line 31 is selectively connected to the first coolant line 11 through a first valve V1.

In addition, the autonomous driving controller 32 is provided in the coolant connection line 31.

Here, the first valve V1 may selectively connect the first coolant line 11 and the coolant connection line 31 between the first water pump 14 and the electrical component 16.

The first valve V1 may be a 4-way valve. As a result, the first valve V1 selectively connects the first coolant line 11 and the coolant connection line 31 to control a flow of the first coolant.

Further, a third water pump 34 may be provided in the coolant connection line 31.

The third water pump 34 may operate the first coolant to be circulated in the coolant connection line 31.

That is, when the first coolant line 11 of the first cooling device 10 is connected to the coolant connection line 31 by selectively operating the first valve V1, the autonomous driving controller cooling device 30 may be connected to the first cooling device 10 so that the first coolant is introduced from the first cooling device 10.

Contrary to this, when the first coolant line 11 and the coolant connection line 31 are not connected by the selectively operating the first valve V1, the autonomous driving controller cooling device 30 may form a closed circuit in which the first coolant is independently circulated along the coolant connection line 31.

As a result, the autonomous driving controller 32 may be selectively connected to the first cooling device 10 through the coolant connection line 31 by operating the first valve V1. In the autonomous driving controller 32, the first coolant may be circulated in the autonomous driving controller 32 by operating the third water pump 34 provided in the coolant connection line 31.

Meanwhile, the first cooling device 10 may include a first branch line 18 connected to the first coolant line 11 between the first radiator 12 and the first water pump 14 through a second valve V2 on the first coolant line 11 between the first radiator 12 and the first water pump 14.

More specifically, the second valve V2 is provided on the first coolant line 11 between the first radiator 12 and the first water pump 14.

One end of the first branch line 18 is connected to the first coolant line 11 through the second valve V2. The other end of the first branch line 18 may be connected to the first coolant line 11 between the electrical component 16 and the first radiator 12.

When the temperature of the coolant is raised by absorbing the waste heat generated from the electrical component 16, the first branch line 18 is selectively opened through the operation of the second valve V2.

In this case, the first coolant line 11 connected to the first radiator 12 may be closed through the operation of the second valve V2.

In the first exemplary embodiment of the present disclosure, the at least one chiller is connected to each of the second coolant line 21 and the coolant connection line 31, and connected to the air conditioning device 50.

The chiller heat-exchanges the first coolant or the second coolant selectively introduced thereinto with the refrigerant supplied from the air conditioning device 50 to adjust the temperature of the first coolant or the second coolant.

That is, the at least one chiller may be a water-cooled heat exchanger into which the first coolant or the second coolant is introduced.

Meanwhile, the air conditioning device 50 may include a compressor, a condenser, an expansion valve, and an evaporator not illustrated, in which the refrigerant is circulated so as to cool or heat the interior of the vehicle by using heat energy generated while the refrigerant is phase-changed.

The compressor compresses the refrigerant and the condenser condenses the refrigerant which is compressed by the compressor. In addition, the expansion valve expands the refrigerant condensed by the condenser and the evaporator evaporates the expanded refrigerant.

The evaporator may be provided inside a Heating, Ventilation, and Air Conditioning (HVAC module, not illustrated) provided in the vehicle.

As a result, the temperatures of the battery module 23 and the autonomous driving controller 32 may be adjusted by the first coolant or the second coolant of which heat exchange with the refrigerant supplied from the air conditioning device 50 while passing through the at least one chiller is completed.

In the first exemplary embodiment of the present disclosure, the at least one chiller may include a first chiller 60 and a second chiller 70.

First, the first chiller 60 is connected to the air conditioning device 50 through a refrigerant connection line 53. In addition, the second chiller 70 is connected to the air conditioning device 50 through a refrigerant line 51.

Here, the first chiller 60 may be arranged in parallel to the second chiller 70 through the refrigerant connection line 53 based on the refrigerant line 51.

Further, the refrigerant connection line 53 may have a first expansion valve 62 and the refrigerant line 51 connected to the second chiller 70 may have a second expansion valve 72.

The first expansion valve 62 may be configured integrally with the first chiller 60 and the second expansion valve 72 may be configured integrally with the second chiller 70.

The first and second expansion valves 62 and 72 may selectively expand the refrigerant supplied through the refrigerant line 51 or the refrigerant connection line 53, and supply the expanded refrigerant to the first and second chillers 60 and 70, respectively.

As a result, the first chiller 60 may heat exchange the second coolant supplied through the second coolant line 21 and the expanded refrigerant supplied from the first expansion valve 62 with each other.

Further, the second chiller 70 may heat exchange the first coolant supplied through the coolant connection line 31 and the expanded refrigerant supplied from the second expansion valve 72 with each other.

As a result, the first and second coolant having a low temperature, of which heat exchange with the refrigerant is completed in the first and second chillers 60 and 70 is introduced into the battery module 23 and the autonomous driving controller 32 through the second coolant line 21 and the coolant connection line 31 to efficiently cool the battery module 23 and the autonomous driving controller 32.

That is, when the autonomous driving controller 32 is cooled by using the coolant cooled by the first radiator 12, the first valve V1 may connect the first coolant line 11 and the coolant connection line 31.

On the contrary, when the autonomous driving controller 32 is cooled by using the first coolant which is heat exchanged with the refrigerant in the second chiller 70 while being circulated in the coolant connection line 31, the first valve V1 may not connect the first coolant line 11 and the coolant connection line 31 so that the coolant connection line 31 forms an independent closed circuit.

Accordingly, according to the cooling system for a vehicle according to the first exemplary embodiment of the present disclosure configured as above, an autonomous driving controller 32 is efficiently cooled by using the coolant by linking the first and second cooling devices 10 and 20 in which the coolant is circulated and the air conditioning device 50 in which refrigerant is circulated in a vehicle in which autonomous driving is available to simplify an entire system and simplify a layout of pipes.

Further, according to the present disclosure, the first and second chillers 60 and 70 are applied, which lower the temperature of the first and second coolant by using the refrigerant circulated in the air conditioning device 50 to more efficiently cool the battery module 23 and the autonomous driving controller 32 by using the low-temperature first and second coolant.

Further, according to the present disclosure, the battery module 23 or the autonomous driving controller 32 is efficiently cooled according to a temperature, a driving condition, or an external environment of each of the battery module 23 and the autonomous driving controller 32 to enhance durability and performance of each of components.

Furthermore, according to the present disclosure, overall merchantability of the vehicle, and customer satisfaction can be enhanced.

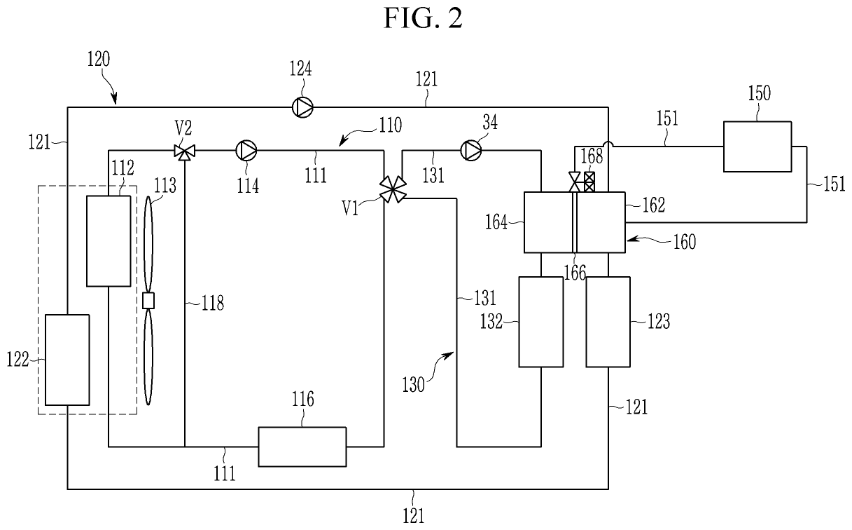

Meanwhile, a cooling system for a vehicle according to a second exemplary embodiment of the present disclosure will be described with FIG. 2 which is accompanied.

FIG. 2 is a block diagram of a cooling system for a vehicle according to a second exemplary embodiment of the present disclosure.

Referring to FIG. 2, the cooling system for a vehicle according to the second exemplary embodiment of the present disclosure is applied to a vehicle capable of autonomous driving.

The vehicle includes a radar, a Lidar, a global positioning system (GPS), and various sensors for the autonomous driving, and includes an autonomous driving controller 132 for controlling the equipments.

Further, the vehicle includes a first cooling device 110, a second cooling device 120, and an autonomous driving controller cooling device 130 cooling at least one electrical component 116, or a battery module 123, or an autonomous driving controller 132 by using first and second coolant, and an air conditioning device 150 cooling or heating a vehicle interior.

That is, referring to FIG. 2, in the second exemplary embodiment of the present disclosure, the cooling system includes the first cooling device 110 for cooling the electrical component 116, the second cooling device 120 for cooling the battery module 123, the autonomous driving controller cooling device 130 for cooling the autonomous driving controller 132, at least chiller 160, and the air conditioning device 150.

First, the first cooling device 110 includes the first radiator 112 and the first water pump 114 connected through the first coolant line 111.

The first cooling device 110 circulates the first coolant to the first coolant line 111 by operating the first water pump 114 so as to cool the electrical component 116.

The first radiator 112 is disposed in front of the vehicle and a cooling fan 113 is provided in the rear of the vehicle to cool the coolant through the operation of the cooling fan 113 and heat exchange with outside air.

Here, the electrical component 116 may include a power control device, an inverter, or an on board charger (OBC). The power control device and the inverter may dissipate heat during driving and the OBC may dissipate heat when the battery module 123 is charged.

The first cooling device 110 configured as such circulates the coolant cooled by the first radiator 112 along the first coolant line 111 by operating the first water pump 114 to cool the electrical component 116 not to be overheated.

In the second exemplary embodiment of the present disclosure, the second cooling device 120 includes a second radiator 122 and a second water pump 124 connected through a second coolant line 121 and circulates the second coolant to the second coolant line 121.

The second cooling device 120 may selectively supply the second coolant cooled by the second radiator 122 to the battery module 123.

The second radiator 122 is disposed on the same line as the first radiator 112 based on the front and rear direction of the vehicle, and heat-exchange the second coolant introduced into the inside with the outside air.

Here, the first radiator 112 and the second radiator 122 may be formed by an integrated form partitioned so as to prevent the first coolant and the second coolant from being mixed.

The second cooling device 120 configured as such may circulate the second coolant cooled by the second radiator 122 along the second coolant line 121 by operating the second water pump 124.

Meanwhile, in the second exemplary embodiment of the present disclosure, it is described as an exemplary embodiment that each of the first and second radiators 112 and 122 are provided and integrally formed, but the present disclosure is not limited thereto, and the exemplary embodiment may be applied to only one radiator of the first and second radiators 112 and 122 and each of the first and second cooling devices 110 and 120 may be connected to one radiator.

In the second exemplary embodiment of the present disclosure, the battery module 123 is provided in the second coolant line 121.

The battery module 123 may be cooled by the second coolant circulated in the second coolant line 121 by operating the second water pump 124.

That is, the battery module 123 may supply electrical power to the electrical component 116, and may be formed into a water-cooled type to be cooled by the coolant flowing along the second coolant line 121.

The autonomous driving controller cooling device 130 may include a coolant connection line 131 and the autonomous driving controller 132.

First, the coolant connection line 131 is selectively connected to the first coolant line 111 through a first valve V1.

In addition, the autonomous driving controller 132 is provided in the coolant connection line 131.

Here, the first valve V1 may selectively connect the first coolant line 111 and the coolant connection line 131 between the first water pump 114 and the electrical component 116.

The first valve V1 may be a 4-way valve. As a result, the first valve V1 selectively connects the first coolant line 111 and the coolant connection line 131 to control a flow of the first coolant.

Further, a third water pump 134 may be provided in the coolant connection line 131.

The third water pump 134 may operate the first coolant to be circulated in the coolant connection line 131.

That is, when the first coolant line 111 of the first cooling device 110 is connected to the coolant connection line 131 by selectively operating the first valve V1, the autonomous driving controller cooling device 130 may be connected to the first cooling device 110 so that the first coolant is introduced from the first cooling device 110.

Contrary to this, when the first coolant line 111 and the coolant connection line 131 are not connected by the selectively operating the first valve V1, the autonomous driving controller cooling device 130 may form a closed circuit in which the first coolant is independently circulated along the coolant connection line 131.

As a result, the autonomous driving controller 132 may be selectively connected to the first cooling device 110 through the coolant connection line 131 by operating the first valve V1. In the autonomous driving controller 132, the first coolant may be circulated in the autonomous driving controller 32 by operating the third water pump 134 provided in the coolant connection line 131.

Meanwhile, the first cooling device 110 may include a first branch line 118 connected to the first coolant line 111 between the first radiator 112 and the first water pump 114 through a second valve V2 on the first coolant line 111 between the first radiator 112 and the first water pump 114.

More specifically, the second valve V2 is provided on the first coolant line 111 between the first radiator 112 and the first water pump 114.

One end of the first branch line 118 is connected to the first coolant line 111 through the second valve V2. The other end of the first branch line 118 may be connected to the first coolant line 111 between the electrical component 116 and the first radiator 112.

When the temperature of the coolant is raised by absorbing the waste heat generated from the electrical component 116, the first branch line 118 is selectively opened through the operation of the second valve V2.

In this case, the first coolant line 111 connected to the first radiator 112 may be closed through the operation of the second valve V2.

In the second exemplary embodiment of the present disclosure, the at least one chiller 160 is connected to each of the second coolant line 121 and the coolant connection line 131, and connected to the air conditioning device 150.

The chiller 160 heat-exchanges the first coolant or the second coolant selectively introduced thereinto with the refrigerant supplied from the air conditioning device 150 to adjust the temperature of the first coolant or the second coolant.

That is, the at least one chiller 160 may be a water-cooled heat exchanger into which the first coolant or the second coolant is introduced. In the second exemplary embodiment of the present disclosure, the chiller 160 may be configured as one.

Meanwhile, the air conditioning device 150 may include a compressor, a condenser, an expansion valve, and an evaporator not illustrated, in which the refrigerant is circulated so as to cool or heat the interior of the vehicle by using heat energy generated while the refrigerant is phase-changed.

The compressor compresses the refrigerant and the condenser condenses the refrigerant which is compressed by the compressor. In addition, the expansion valve expands the refrigerant condensed by the condenser and the evaporator evaporates the expanded refrigerant.

The evaporator may be provided inside a Heating, Ventilation, and Air Conditioning (HVAC module, not illustrated) provided in the vehicle.

As a result, the temperatures of the battery module 123 and the autonomous driving controller 132 may be adjusted by the first coolant or the second coolant of which heat exchange with the refrigerant supplied from the air conditioning device 150 while passing through the at least one chiller is completed.

In the second exemplary embodiment of the present disclosure, the chiller 160 may include a first heat dissipation unit 162, a second heat dissipation unit 164, and a partition 166.

First, the first heat dissipation unit 162 is connected to the second coolant line 121. As a result, the first heat dissipation unit 162 may make the refrigerant supplied from the air conditioning device 150 to exchange heat with the second coolant supplied from the second cooling device 120.

The second heat dissipation unit 164 is connected to the coolant connection line 131. As a result, the second heat dissipation unit 164 may make the refrigerant supplied from the air conditioning device 150 to exchange heat with the first coolant circulated in the autonomous driving controller cooling device 130.

In addition, the partition 166 may partition the first heat dissipation unit 162 and the second heat dissipation unit 164 in the chiller 160 so as to prevent the first and second coolant supplied from the second cooling device 120 and the autonomous driving controller cooling device 130, respectively from being mixed.

The partition 166 may pass the refrigerant so that the refrigerant supplied from the air conditioning device 150 flows in the first heat dissipation unit 162 and the second heat dissipation unit 164.

Here, the first heat dissipation unit 162 and the second heat dissipation unit 164 may be integrally configured through the chiller 160.

Further, an expansion valve 168 may be provided in the refrigerant line 151 connected to the chiller 160. The expansion valve 168 may be configured integrally with the chiller 160.

The expansion valve 168 may selectively expand the refrigerant supplied through the refrigerant line 151 and supply the expanded refrigerant to the first heat dissipation unit 162 and the second heat dissipation unit 164.

As a result, the first heat dissipation unit 162 may heat exchange the second coolant supplied through the second coolant line 121 and the expanded refrigerant supplied from the expansion valve 168 with each other.

That is, the second coolant passing through the first heat dissipation unit 162 may be supplied to the battery module 123 along the second coolant line 121.

Further, the second heat dissipation unit 164 may heat exchange the first coolant supplied through the coolant connection line 131 and the expanded refrigerant supplied from the expansion valve 168 with each other.

That is, the first coolant passing through the second heat dissipation unit 164 may be supplied to the autonomous driving controller 132 along the coolant connection line 131.

In other words, the first and second coolant having a low temperature, of which heat exchange with the refrigerant is completed in the first and second heat dissipation units 162 and 164 is introduced into the battery module 123 and the autonomous driving controller 132 through the second coolant line 121 and the coolant connection line 131 to efficiently cool the battery module 123 and the autonomous driving controller 132.

That is, when the autonomous driving controller 132 is cooled by using the coolant cooled by the first radiator 112, the first valve V1 may connect the first coolant line 111 and the coolant connection line 131.

On the contrary, when the autonomous driving controller 132 is cooled by using the first coolant which is heat exchanged with the refrigerant in the chiller 160 while being circulated in the coolant connection line 131, the first valve V1 may not connect the first coolant line 111 and the coolant connection line 131 so that the coolant connection line 131 forms an independent closed circuit.

Accordingly, according to the cooling system for a vehicle according to the second exemplary embodiment of the present disclosure configured as above, an autonomous driving controller 132 is efficiently cooled by using the coolant by linking the first and second cooling devices 110 and 120 in which the coolant is circulated and the air conditioning device 150 in which refrigerant is circulated in a vehicle in which autonomous driving is available to simplify an entire system and simplify a layout of pipes.

Further, according to the present disclosure, the chiller 160 is applied, which lowers the temperature of the first and second coolant by using the refrigerant circulated in the air conditioning device 150 to more efficiently cool the battery module 123 and the autonomous driving controller 132 by using the low-temperature first and second coolant.

Further, according to the present disclosure, the battery module 123 or the autonomous driving controller 132 is efficiently cooled according to a temperature, a driving condition, or an external environment of each of the battery module 123 and the autonomous driving controller 132 to enhance durability and performance of each of components.

Furthermore, according to the present disclosure, overall merchantability of the vehicle, and customer satisfaction can be enhanced.

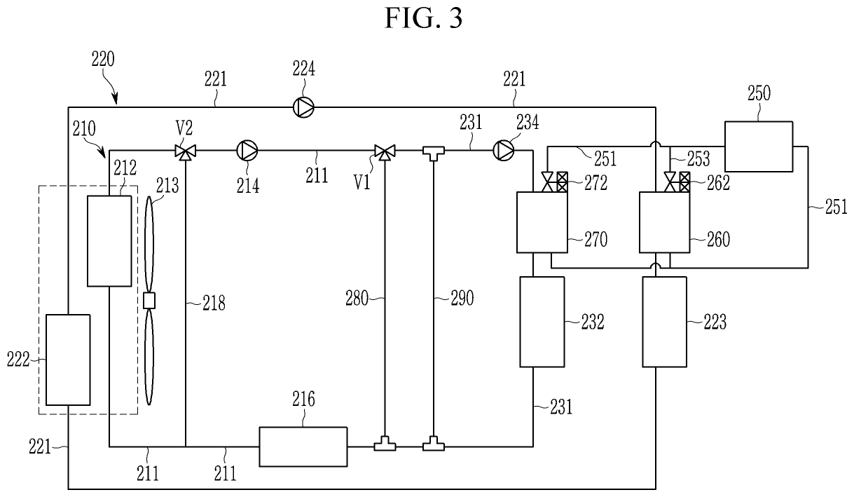

Meanwhile, a cooling system for a vehicle according to a third exemplary embodiment of the present disclosure will be described with FIG. 3 which is accompanied.

FIG. 3 is a block diagram of a cooling system for a vehicle according to a third exemplary embodiment of the present disclosure.

Referring to FIG. 3, the cooling system for a vehicle according to the third exemplary embodiment of the present disclosure is applied to a vehicle capable of autonomous driving.

The vehicle includes a radar, a Lidar, a global positioning system (GPS), and various sensors for the autonomous driving, and includes an autonomous driving controller 232 for controlling the equipments.

Further, the vehicle includes a first cooling device 210 and a second cooling device 220 cooling at least one electrical component 216, or a battery module 223, or an autonomous driving controller 232 by using first and second coolant, and an air conditioning device 250 cooling or heating a vehicle interior.

That is, referring to FIG. 3, in the third exemplary embodiment of the present disclosure, the cooling system includes the first cooling device 210 for cooling the electrical component 216, the second cooling device 220 for cooling the battery module 223, the autonomous driving controller 232, at least chiller, and the air conditioning device 250.

First, the first cooling device 210 includes the first radiator 212 and the first water pump 214 connected through the first coolant line 211.

The first cooling device 210 circulates the first coolant to the first coolant line 211 by operating the first water pump 214 so as to cool the electrical component 216.

The first radiator 212 is disposed in front of the vehicle and a cooling fan 213 is provided in the rear of the vehicle to cool the coolant through the operation of the cooling fan 213 and heat exchange with outside air.

Here, the electrical component 216 may include a power control device, an inverter, or an on board charger (OBC). The power control device and the inverter may dissipate heat during driving and the OBC may dissipate heat when the battery module 223 is charged.

The first cooling device 210 configured as such circulates the coolant cooled by the first radiator 212 along the first coolant line 211 by operating the first water pump 214 to cool the electrical component 216 not to be overheated.

In the third exemplary embodiment of the present disclosure, the second cooling device 220 includes a second radiator 222 and a second water pump 224 connected through a second coolant line 221 and circulates the second coolant to the second coolant line 221.

The second cooling device 220 may selectively supply the second coolant cooled by the second radiator 222 to the battery module 223.

The second radiator 222 is disposed on the same line as the first radiator 212 based on the front and rear direction of the vehicle, and heat-exchange the second coolant introduced into the inside with the outside air.

Here, the first radiator 212 and the second radiator 222 may be formed by an integrated form partitioned so as to prevent the first coolant and the second coolant from being mixed.

The second cooling device 220 configured as such may circulate the second coolant cooled by the second radiator 222 along the second coolant line 221 by operating the second water pump 226.

Meanwhile, in the third exemplary embodiment of the present disclosure, it is described as an exemplary embodiment that each of the first and second radiators 212 and 222 are provided and integrally formed, but the present disclosure is not limited thereto, and one radiator of the first and second radiators 212 and 222 may be applied and each of the first and second cooling devices 210 and 220 may be connected to one radiator.

In the third exemplary embodiment of the present disclosure, the battery module 223 is provided in the second coolant line 221.

The battery module 223 may be cooled by the second coolant circulated in the second coolant line 221 by operating the second water pump 224.

That is, the battery module 223 may supply electrical power to the electrical component 216, and may be formed into a water-cooled type to be cooled by the coolant flowing along the second coolant line 221.

The autonomous driving controller 232 is provided on a coolant connection line 231 selectively connected to the first coolant line 211 through the first valve V1. The first coolant may flow in the coolant connection line 231.

Here, the first valve V1 may selectively connect the first coolant line 211 and the coolant connection line 231 between the first radiator 212 and the autonomous driving controller 232.

The autonomous driving controller 232 may control the radar, the Lidar, the global positioning system (GPS), and various sensors, and may be formed in a water cooled type which is cooled by the first coolant which flows along the coolant connection line 231.

That is, the autonomous driving controller 232 is selectively connected to the first cooling device 210 through the coolant connection line 231 according to the operation of the first valve V1. In the autonomous driving controller 232, the first coolant may be circulated in the autonomous driving controller 232 by operating a third water pump 234 provided in the coolant connection line 231.

The third water pump 234 is provided in the coolant connection line 231. The third water pump 234 may operate the first coolant to be circulated in the coolant connection line 231.

Meanwhile, the first cooling device 210 may include a first branch line 218 connected to the first coolant line 211 between the first radiator 212 and the first water pump 214 through a second valve V2 on the first coolant line 211 between the first radiator 212 and the first water pump 214.

More specifically, the second valve V2 is provided on the first coolant line 211 between the first radiator 212 and the first water pump 214.

One end of the first branch line 218 is connected to the first coolant line 211 through the second valve V2. The other end of the first branch line 218 may be connected to the first coolant line 211 between the electrical component 216 and the first radiator 212.

When the temperature of the coolant is raised by absorbing the waste heat generated from the electrical component 216, the first branch line 218 is selectively opened through the operation of the second valve V2.

In this case, the first coolant line 211 connected to the first radiator 212 may be closed through the operation of the second valve V2.

In the third exemplary embodiment of the present disclosure, the at least one chiller is connected to each of the second coolant line 221 and the coolant connection line 231, and connected to the air conditioning device 250.

The chiller heat-exchanges the first coolant or the second coolant selectively introduced thereinto with the refrigerant supplied from the air conditioning device 250 to adjust the temperature of the first coolant or the second coolant.

That is, the at least one chiller may be a water-cooled heat exchanger into which the first coolant or the second coolant is introduced.

Meanwhile, the air conditioning device 250 may include a compressor, a condenser, an expansion valve, and an evaporator not illustrated, in which the refrigerant is circulated so as to cool or heat the interior of the vehicle by using heat energy generated while the refrigerant is phase-changed.

The compressor compresses the refrigerant and the condenser condenses the refrigerant which is compressed by the compressor. In addition, the expansion valve expands the refrigerant condensed by the condenser and the evaporator evaporates the expanded refrigerant.

The evaporator may be provided inside a Heating, Ventilation, and Air Conditioning (HVAC module, not illustrated) provided in the vehicle.

As a result, the temperatures of the battery module 223 and the autonomous driving controller 232 may be adjusted by the first coolant or the second coolant of which heat exchange with the refrigerant supplied from the air conditioning device 250 while passing through the at least one chiller is completed.

In the third exemplary embodiment of the present disclosure, the at least one chiller may include a first chiller 260 and a second chiller 270.

First, the first chiller 260 is connected to the air conditioning device 250 through a refrigerant connection line 253. In addition, the second chiller 270 is connected to the air conditioning device 250 through a refrigerant line 251.

Here, the first chiller 260 may be arranged in parallel to the second chiller 270 through the refrigerant connection line 253 based on the refrigerant line 251.

Further, the refrigerant connection line 253 may have a first expansion valve 262 and the refrigerant line 251 connected to the second chiller 70 may have a second expansion valve 272.

The first expansion valve 262 may be configured integrally with the first chiller 260 and the second expansion valve 272 may be configured integrally with the second chiller 270.

The first and second expansion valves 262 and 272 may selectively expand the refrigerant supplied through the refrigerant line 251 or the refrigerant connection line 253, and supply the expanded refrigerant to the first and second chillers 260 and 270, respectively.

As a result, the first chiller 260 may heat exchange the second coolant supplied through the second coolant line 221 and the expanded refrigerant supplied from the first expansion valve 262 with each other.

Further, the second chiller 270 may heat exchange the first coolant supplied through the coolant connection line 231 and the expanded refrigerant supplied from the second expansion valve 272 with each other.

As a result, the first and second coolant having a low temperature, of which heat exchange with the refrigerant is completed in the first and second chillers 260 and 270 is introduced into the battery module 223 and the autonomous driving controller 232 through the second coolant line 221 and the coolant connection line 231 to efficiently cool the battery module 223 and the autonomous driving controller 232.

Meanwhile, in the third exemplary embodiment of the present disclosure, a second branch line 280 may be provided in the first cooling device 210, which selectively disconnects the coolant connection line 231 and the first coolant line 211 according to the operation of the first valve V1.

The second branch line 280 may selectively connect the first coolant line 211 through the operation of the first valve V1 so that the first cooling device 210 forms an independent closed circuit with the coolant connection line 231.

That is, one end of the second branch line 280 is connected to the first valve V1. In addition, the other end of the second branch line 280 may be connected to a location where the first coolant line 211 and the coolant connection line 231 are connected, between the electrical component 216 and the autonomous driving controller 232.

Further, a third branch line 290 is provided on the coolant connection line 231, which selectively disconnects the coolant connection line 231 and the first coolant line 211.

The third branch line 290 may be selectively connected to the coolant connection line 231 so that the autonomous driving controller 232 and the second chiller 270 form the independent closed circuit through the coolant connection line 231.

Here, one end of the third branch line 290 is connected to the coolant connection line 231 between the first valve V1 and the third water pump 234. In addition, the other end of the third branch line 290 may be connected to the coolant connection line 231 between the second branch line 280 and the autonomous driving controller 232.

Meanwhile, in the third exemplary embodiment, it is described that the valve is not configured in the third branch line 290 as an exemplary embodiment, but the present disclosure is not limited thereto and the valve is applicable as necessary for selective opening of the third branch line 290.

That is, a separate valve may be provided at a point where the third branch line 290 intersects the first coolant line 211 and the coolant connection line 231, or the third branch line 290. Such a valve may be a 3-way or 2-way valve.

In the third exemplary embodiment of the present disclosure, the first valve V1 selectively connects the first coolant line 211 and the coolant connection line 231 or selectively connects the first coolant line 211 and the second branch line 280 to control the flow of the coolant.

Here, the first valve V1 may be a 3-way valve.

That is, when the autonomous driving controller 232 is cooled by using the coolant cooled by the first radiator 212, the first valve V1 may connect the first coolant line 211 and the coolant connection line 231, and close the second branch line 280.

On the contrary, when the autonomous driving controller 232 is cooled by using the first coolant which is heat exchanged with the refrigerant in the second chiller 270 while being circulated in the coolant connection line 231, the first valve V1 may open the second branch line 280 and not connect the first coolant line 211 and the coolant connection line 231 so that the coolant connection line 231 forms an independent closed circuit. In this case, the third branch line 290 may be opened.

Then, the third branch line 290 may connect the coolant connection line 231 so that the autonomous driving controller 232 forms the independent closed circuit through the coolant connection line 231.

Accordingly, the first coolant having a low temperature, of which heat exchange with the refrigerant is completed in the second chiller 270 is introduced into the autonomous driving controller 232 through the third branch line 290 opened by the first valve V1, thereby efficiently cooling the autonomous driving controller 232.

Meanwhile, in the third exemplary embodiment, it is described that the valve is not configured in the third branch line 290 as an exemplary embodiment, but the present disclosure is not limited thereto and the valve is applicable as necessary for selective opening of the third branch line 290.

That is, the third branch line 290 may be selectively opened and closed according to a flow control of the coolant circulated by operating the coolant connection line 231 selectively connected to the first coolant line 211 according to the operation of the first valve V1, or the first branch line 218, and the first and third water pumps 214 and 234.

Meanwhile, in the third exemplary embodiment of the present disclosure, it is described as an exemplary embodiment that the autonomous driving controller 232 is provided on the coolant connection line 231, but the present disclosure is not limited thereto.

That is, although not illustrated in the drawing, the autonomous driving controller 232 may be provided on a front end or a rear end of the electrical component 216 in the first coolant line 211.

When the autonomous driving controller 232 is provided on the first coolant line 211 on the front end of the electrical component 216, a bypass line (not illustrated) may be provided in the first cooling device 210, in which one end is branched from the first coolant line 211 on the rear end of the autonomous driving controller 232 and the other end is connected to the first coolant line 211 on the rear end of the electrical component 216.

On the contrary, when the autonomous driving controller 232 is provided on the first coolant line 211 on the rear end of the electrical component 216, a bypass line (not illustrated) may be provided in the first cooling device 210, in which one end is branched from the first coolant line 211 on the front end of the electrical component 216 and the other end is connected to the first coolant line 211 on the front end of the autonomous driving controller 232.

Accordingly, according to the cooling system for a vehicle according to the third exemplary embodiment of the present disclosure configured as above, an autonomous driving controller 232 is efficiently cooled by using the coolant by linking the first and second cooling devices 210 and 220 in which the coolant is circulated and the air conditioning device 250 in which refrigerant is circulated in a vehicle in which autonomous driving is available to simplify an entire system and simplify a layout of pipes.

Further, according to the present disclosure, the first and second chillers 260 and 270 are applied, which lower the temperature of the first and second coolant by using the refrigerant circulated in the air conditioning device 250 to more efficiently cool the battery module 223 and the autonomous driving controller 232 by using the low-temperature first and second coolant.

Further, according to the present disclosure, the battery module 223 or the autonomous driving controller 232 is efficiently cooled according to a temperature, a driving condition, or an external environment of each of the battery module 223 and the autonomous driving controller 232 to enhance durability and performance of each of components.

Furthermore, according to the present disclosure, overall merchantability of the vehicle, and customer satisfaction can be enhanced.

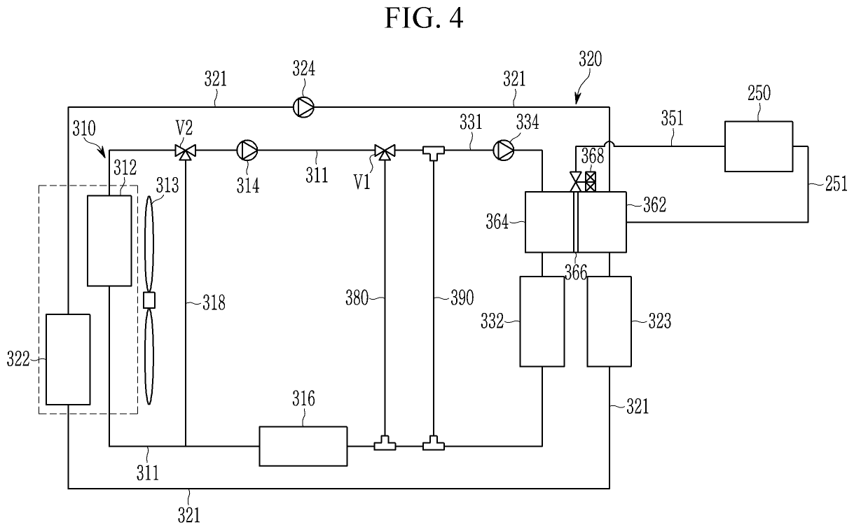

In addition, a cooling system for a vehicle according to a fourth exemplary embodiment of the present disclosure will be described with FIG. 4 which is accompanied.

FIG. 4 is a block diagram of a cooling system for a vehicle according to a fourth exemplary embodiment of the present disclosure.

Referring to FIG. 4, the cooling system for a vehicle according to the fourth exemplary embodiment of the present disclosure is applied to a vehicle capable of autonomous driving.

The vehicle includes a radar, a Lidar, a global positioning system (GPS), and various sensors for the autonomous driving, and includes an autonomous driving controller 332 for controlling the equipments.

Further, the vehicle includes a first cooling device 310 and a second cooling device 320 cooling at least one electrical component 316, or a battery module 323, or an autonomous driving controller 332 by using first and second coolant, and an air conditioning device 350 cooling or heating a vehicle interior.

That is, referring to FIG. 4, in the fourth exemplary embodiment of the present disclosure, the cooling system includes the first cooling device 310 for cooling the electrical component 316, the second cooling device 320 for cooling the battery module 323, the autonomous driving controller 332, at least chiller, and the air conditioning device 350.

First, the first cooling device 310 includes the first radiator 312 and the first water pump 314 connected through the first coolant line 311.

The first cooling device 310 circulates the first coolant to the first coolant line 311 by operating the first water pump 314 so as to cool the electrical component 316.

The first radiator 312 is disposed in front of the vehicle and a cooling fan 313 is provided in the rear of the vehicle to cool the coolant through the operation of the cooling fan 313 and heat exchange with outside air.

Here, the electrical component 316 may include a power control device, an inverter, or an on board charger (OBC). The power control device and the inverter may dissipate heat during driving and the OBC may dissipate heat when the battery module 323 is charged.

The first cooling device 310 configured as such circulates the coolant cooled by the first radiator 312 along the first coolant line 311 by operating the first water pump 314 to cool the electrical component 316 not to be overheated.

In the fourth exemplary embodiment of the present disclosure, the second cooling device 320 includes a second radiator 322 and a second water pump 324 connected through a second coolant line 321 and circulates the second coolant to the second coolant line 321.

The second cooling device 320 may selectively supply the second coolant cooled by the second radiator 322 to the battery module 323.

The second radiator 322 is disposed on the same line as the first radiator 312 based on the front and rear direction of the vehicle, and heat-exchange the second coolant introduced into the inside with the outside air.

Here, the first radiator 312 and the second radiator 322 may be formed by an integrated form partitioned so as to prevent the first coolant and the second coolant from being mixed.

The second cooling device 320 configured as such may circulate the second coolant cooled by the second radiator 322 along the second coolant line 321 by operating the second water pump 326.

Meanwhile, in the fourth exemplary embodiment of the present disclosure, it is described as an exemplary embodiment that each of the first and second radiators 312 and 322 are provided and integrally formed, but the present disclosure is not limited thereto, and one radiator of the first and second radiators 312 and 322 may be applied and each of the first and second cooling devices 310 and 320 may be connected to one radiator.

In the fourth exemplary embodiment of the present disclosure, the battery module 323 is provided in the second coolant line 321.

The battery module 323 may be cooled by the second coolant circulated in the second coolant line 321 by operating the second water pump 324.

That is, the battery module 323 may supply electrical power to the electrical component 316, and may be formed into a water-cooled type to be cooled by the coolant flowing along the second coolant line 321.

The autonomous driving controller 332 is provided on a coolant connection line 331 selectively connected to the coolant line 311 through the first valve V1. The first coolant may flow in the coolant connection line 331.

Here, the first valve V1 may selectively connect the coolant line 311 and the coolant connection line 331 between the first radiator 312 and the autonomous driving controller 332.

The autonomous driving controller 332 may control the radar, the Lidar, the global positioning system (GPS), and various sensors, and may be formed in a water cooled type which is cooled by the first coolant which flows along the coolant connection line 331.

That is, the autonomous driving controller 332 is selectively connected to the first cooling device 310 through the coolant connection line 331 according to the operation of the first valve V1. In the autonomous driving controller 332, the first coolant may be circulated in the autonomous driving controller 332 by operating the third water pump 334 provided in the coolant connection line 331.

The third water pump 334 is provided in the coolant connection line 331. The third water pump 334 may operate the first coolant to be circulated in the coolant connection line 331.

Meanwhile, the first cooling device 310 may include a first branch line 318 connected to the first coolant line 311 between the first radiator 312 and the first water pump 314 through a second valve V2 on the first coolant line 311 between the first radiator 312 and the first water pump 314.

More specifically, the second valve V2 is provided on the first coolant line 311 between the first radiator 312 and the first water pump 314.

One end of the first branch line 318 is connected to the first coolant line 311 through the second valve V2. The other end of the first branch line 318 may be connected to the first coolant line 311 between the electrical component 316 and the first radiator 312.

When the temperature of the coolant is raised by absorbing the waste heat generated from the electrical component 316, the first branch line 318 is selectively opened through the operation of the second valve V2.

In this case, the first coolant line 311 connected to the first radiator 312 may be closed through the operation of the second valve V2.

In the fourth exemplary embodiment of the present disclosure, the at least one chiller is connected to each of the second coolant line 321 and the coolant connection line 331, and connected to the air conditioning device 350.

The chiller heat-exchanges the first coolant or the second coolant selectively introduced thereinto with the refrigerant supplied from the air conditioning device 350 to adjust the temperature of the first coolant or the second coolant.

That is, the at least one chiller may be a water-cooled heat exchanger into which the first coolant or the second coolant is introduced.

Meanwhile, the air conditioning device 350 may include a compressor, a condenser, an expansion valve, and an evaporator not illustrated, in which the refrigerant is circulated so as to cool or heat the interior of the vehicle by using heat energy generated while the refrigerant is phase-changed.

The compressor compresses the refrigerant and the condenser condenses the refrigerant which is compressed by the compressor. In addition, the expansion valve expands the refrigerant condensed by the condenser and the evaporator evaporates the expanded refrigerant.

The evaporator may be provided inside a Heating, Ventilation, and Air Conditioning (HVAC module, not illustrated) provided in the vehicle.

As a result, the temperatures of the battery module 323 and the autonomous driving controller 332 may be adjusted by the first coolant or the second coolant of which heat exchange with the refrigerant supplied from the air conditioning device 350 while passing through the at least one chiller is completed.

In the fourth exemplary embodiment of the present disclosure, the chiller 360 may include a first heat dissipation unit 362, a second heat dissipation unit 364, and a partition 366.

First, the first heat dissipation unit 362 is connected to the second coolant line 321. As a result, the first heat dissipation unit 362 may make the refrigerant supplied from the air conditioning device 350 to exchange heat with the second coolant supplied from the second cooling device 320.

The second heat dissipation unit 364 is connected to the coolant connection line 331. As a result, the second heat dissipation unit 364 may make the refrigerant supplied from the air conditioning device 350 to exchange heat with the first coolant circulated in the autonomous driving controller cooling device 330.

In addition, the partition 366 may partition the first heat dissipation unit 362 and the second heat dissipation unit 364 in the chiller 360 so as to prevent the first and second coolant supplied from the second cooling device 320 and the coolant connection line 331, respectively from being mixed.

The partition 366 may pass the refrigerant so that the refrigerant supplied from the air conditioning device 350 flows in the first and second heat dissipation units 362 and 364.

Here, the first heat dissipation unit 362 and the second heat dissipation unit 364 may be integrally configured through the chiller 360.

Further, an expansion valve 368 may be provided in the refrigerant line 351 connected to the chiller 360. The expansion valve 368 may be configured integrally with the chiller 360.

The expansion valve 368 may selectively expand the refrigerant supplied through the refrigerant line 351 and supply the expanded refrigerant to the first heat dissipation unit 362 and the second heat dissipation unit 364.

As a result, the first heat dissipation unit 362 may heat exchange the second coolant supplied through the second coolant line 321 and the expanded refrigerant supplied from the expansion valve 368 with each other.

That is, the second coolant passing through the first heat dissipation unit 362 may be supplied to the battery module 323 along the second coolant line 321.

Further, the second heat dissipation unit 364 may heat exchange the first coolant supplied through the coolant connection line 331 and the expanded refrigerant supplied from the expansion valve 368 with each other.

That is, the first coolant passing through the second heat dissipation unit 364 may be supplied to the autonomous driving controller 332 along the coolant connection line 331.

In other words, the first and second coolant having a low temperature, of which heat exchange with the refrigerant is completed in the first and second heat dissipation units 362 and 364 is introduced into the battery module 323 and the autonomous driving controller 332 through the second coolant line 321 and the coolant connection line 331 to efficiently cool the battery module 323 and the autonomous driving controller 332.

Meanwhile, in the fourth exemplary embodiment of the present disclosure, a second branch line 380 may be provided in the first cooling device 310, which selectively disconnects the coolant connection line 331 and the first coolant line 311 according to the operation of the first valve V1.

The second branch line 380 may selectively connect the first coolant line 311 through the operation of the first valve V1 so that the first cooling device 310 forms an independent closed circuit with the coolant connection line 331.

That is, one end of the second branch line 380 is connected to the first valve V1. In addition, the other end of the second branch line 380 may be connected to a location where the first coolant line 311 and the coolant connection line 331 are connected, between the electrical component 316 and the autonomous driving controller 332.

Further, a third branch line 390 is provided on the coolant connection line 331, which selectively disconnects the coolant connection line 331 and the first coolant line 311.

The third branch line 390 may be selectively connected to the coolant connection line 331 so that the autonomous driving controller 332 and the second chiller 370 form the independent closed circuit through the coolant connection line 331.

Here, one end of the third branch line 390 is connected to the coolant connection line 331 between the first valve V1 and the third water pump 334. In addition, the other end of the third branch line 390 may be connected to the coolant connection line 331 between the second branch line 380 and the autonomous driving controller 332.

Meanwhile, in the fourth exemplary embodiment, it is described that the valve is not configured in the third branch line 390 as an exemplary embodiment, but the present disclosure is not limited thereto and the valve is applicable as necessary for selective opening of the third branch line 390.

That is, a separate valve may be provided at a point where the third branch line 390 intersects the first coolant line 311 and the coolant connection line 331, or the third branch line 390. Such a valve may be a 3-way or 2-way valve.

In the fourth exemplary embodiment of the present disclosure, the first valve V1 selectively connects the first coolant line 311 and the coolant connection line 331 or selectively connects the first coolant line 311 and the second branch line 380 to control the flow of the coolant.

Here, the first valve V1 may be a 3-way valve.

That is, when the autonomous driving controller 332 is cooled by using the coolant cooled by the first radiator 312, the first valve V1 may connect the first coolant line 311 and the coolant connection line 331, and close the second branch line 380.

On the contrary, when the autonomous driving controller 332 is cooled by using the first coolant which is heat exchanged with the refrigerant in the second heat dissipation unit 364 while being circulated in the coolant connection line 331, the first valve V1 may open the second branch line 380 and not connect the first coolant line 311 and the coolant connection line 331 so that the coolant connection line 331 forms an independent closed circuit. In this case, the third branch line 390 may be opened.

Then, the third branch line 390 may connect the coolant connection line 331 so that the autonomous driving controller 332 forms the independent closed circuit through the coolant connection line 331.

Accordingly, the first coolant having a low temperature, of which heat exchange with the refrigerant is completed in the second heat dissipation unit 364 is introduced into the autonomous driving controller 332 through the third branch line 390 opened by the first valve V1, thereby efficiently cooling the autonomous driving controller 332.

Meanwhile, in the exemplary embodiment, it is described that the valve is not configured in the third branch line 390 as an exemplary embodiment, but the present disclosure is not limited thereto and the valve is applicable as necessary for selective opening of the third branch line 390.

That is, the third branch line 390 may be selectively opened and closed according to a flow control of the coolant circulated by operating the coolant connection line 331 selectively connected to the first coolant line 311 according to the operation of the first valve V1, or the first branch line 380, and the first and third water pumps 314 and 334.

Meanwhile, in the fourth exemplary embodiment of the present disclosure, it is described as an exemplary embodiment that the autonomous driving controller 332 is provided on the coolant connection line 331, but the present disclosure is not limited thereto.

That is, although not illustrated in the drawing, the autonomous driving controller 332 may be provided on a front end or a rear end of the electrical component 316 in the first coolant line 311.

When the autonomous driving controller 332 is provided on the first coolant line 311 on the front end of the electrical component 316, a bypass line (not illustrated) may be provided in the first cooling device 310, in which one end is branched from the first coolant line 311 on the rear end of the autonomous driving controller 332 and the other end is connected to the first coolant line 311 on the rear end of the electrical component 316.

On the contrary, when the autonomous driving controller 332 is provided on the first coolant line 311 on the rear end of the electrical component 316, a bypass line (not illustrated) may be provided in the first cooling device 310, in which one end is branched from the first coolant line 311 on the front end of the electrical component 316 and the other end is connected to the first coolant line 311 on the front end of the autonomous driving controller 332.

Accordingly, according to the cooling system for a vehicle according to the fourth exemplary embodiment of the present disclosure configured as above, an autonomous driving controller 332 is efficiently cooled by using the coolant by linking the first and second cooling devices 310 and 320 in which the coolant is circulated and the air conditioning device 350 in which refrigerant is circulated in a vehicle in which autonomous driving is available to simplify an entire system and simplify a layout of pipes.

Further, according to the present disclosure, the chiller 360 is applied, which lowers the temperature of the first and second coolant by using the refrigerant circulated in the air conditioning device 350 to more efficiently cool the battery module 323 and the autonomous driving controller 332 by using the low-temperature first and second coolant.

Further, according to the present disclosure, the battery module 323 or the autonomous driving controller 332 is efficiently cooled according to a temperature, a driving condition, or an external environment of each of the battery module 323 and the autonomous driving controller 332 to enhance durability and performance of each of components.

Furthermore, according to the present disclosure, overall merchantability of the vehicle, and customer satisfaction can be enhanced.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A cooling system for a vehicle, comprising:
a first cooling device including a first radiator and a first water pump connected by a first coolant line, and circulating first coolant in the first coolant line to cool at least one electrical component;
a second cooling device including a second radiator and a second water pump connected by a second coolant line, and circulating second coolant in the second coolant line;
a battery module provided in the second coolant line;
an autonomous driving controller cooling device including a coolant connection line selectively connected to the first coolant line through a first value, in which the first coolant flows, and an autonomous driving controller provided on the coolant connection line; and
at least one chiller connected to each of the second coolant line and the coolant connection line, and connected to an air conditioning device, and heat-exchanging the first coolant or the second coolant which is selectively introduced with a refrigerant supplied from the air conditioning device to adjust a temperature of the first coolant or the second coolant,
wherein temperatures of the battery module and the autonomous driving controller
are adjusted by the first coolant or the second coolant passing through the at least one chiller.

2. The cooling system of claim 1, wherein:
the at least one chiller includes
a first chiller connected to the air conditioning device through a refrigerant connection line, and
a second chiller connected to the air conditioning device through a refrigerant line.

3. The cooling system of claim 2, wherein:
the first chiller is disposed in parallel to the second chiller through the refrigerant connection line based on the refrigerant line.

4. The cooling system of claim 2, wherein:
a first expansion valve is provided on the refrigerant connection line, and
a second expansion valve is provided on the refrigerant line connected to the second chiller.

5. The cooling system of claim 1, wherein:
on the coolant connection line, a third water pump is provided.

6. The cooling system of claim 1, wherein:
the at least one chiller includes
a first heat dissipation unit connected to the second coolant line,
a second heat dissipation unit connected to the coolant connection line, and
a partition partitioning the first heat dissipation unit and the second heat dissipation unit inside the chiller so as to prevent the first and second coolant supplied through the second coolant line and the coolant connection line, respectively from being mixed, and passing the refrigerant.

7. The cooling system of claim 6, wherein:
the first heat dissipation unit and the second heat dissipation unit are integrally configured, and an expansion valve is provided on the refrigerant line connected to the at least one chiller.

8. The cooling system of claim 6, wherein:
the second coolant passing through the first heat dissipation unit is supplied to the battery module along the second coolant line, and
the first coolant passing through the second heat dissipation unit is supplied to the autonomous driving controller along the coolant connection line.

9. The cooling system of claim 1, wherein:
a first valve configured to selectively connect the coolant connection line to the first coolant line, wherein the first valve is a 4-way valve.

10. The cooling system of claim 1, wherein:
the first radiator and the second radiator are formed in an integrated form partitioned to prevent the first and second coolant from being mixed.

11. The cooling system of claim 1, wherein:
the first cooling device further includes a first branch line connected to the first coolant line between the first radiator and the first water pump through a second valve provided on the first coolant line between the first radiator and the first water pump.

12. A cooling system for a vehicle, comprising:
a first cooling device including a first radiator and a first water pump connected by a first coolant line, and circulating first coolant in the first coolant line to cool at least one electrical component;
a second cooling device including a second radiator and a second water pump connected by a second coolant line, and circulating second coolant in the second coolant line;
a coolant connection line selectively connected to the first coolant line through a first valve, in which the first coolant flows;
a battery module provided in the second coolant line;
an autonomous driving controller provided on the coolant connection line;
at least one chiller connected to each of the second coolant line and the coolant connection line, and connected to an air conditioning device, and heat-exchanging the first coolant or the second coolant which is selectively introduced with refrigerant supplied from the air conditioning device to adjust a temperature of the first coolant or the second coolant;
a first branch line connected to the first coolant line between the first radiator and the first water pump through a second valve provided on the first coolant line between the first radiator and the first water pump;
a second branch line selectively disconnecting the coolant connection line and the first coolant line according to a selective operation of the first valve; and
a third branch line selectively connecting the coolant connection line so that the coolant connection line forms a closed circuit independent from the first cooling device according to the selective operation of the first valve,
wherein temperatures of the battery module and the autonomous driving controller are adjusted by coolant cooled while passing through the at least one chiller.

13. The cooling system of claim 12, wherein:
one of the second branch line is connected to the first valve, and
the other end of the second branch line is connected to a location where the first coolant line and the coolant connection line are connected between the at least one electrical component and the third branch line.

14. The cooling system of claim 12, wherein:
on the coolant connection line, a third water pumps is provided.

15. The cooling system of claim 14, wherein:
one end of the third branch line is connected to the coolant connection line between the first valve and the third water pump, and
the other end of the third branch line is connected to the coolant connection line between the second branch line and the autonomous driving controller.

16. The cooling system of claim 12, wherein:
the at least one chiller includes
a first chiller connected to the air conditioning device through a refrigerant connection line, and
a second chiller connected to the air conditioning device through a refrigerant line.

17. The cooling system of claim 16, wherein:
the first chiller is disposed in parallel to the second chiller through the refrigerant connection line based on the refrigerant line.

18. The cooling system of claim 16, wherein:
a first expansion valve is provided on the refrigerant connection line, and
a second expansion valve is provided on a refrigerant line connected to the second chiller.

19. The cooling system of claim 12, wherein:
the at least one chiller includes
a first heat dissipation unit connected to the second coolant line,
a second heat dissipation unit connected to the coolant connection line, and
a partition partitioning the first heat dissipation unit and the second heat dissipation unit inside the chiller so as to prevent the first and second coolant supplied through the second coolant line and the coolant connection line, respectively from being mixed, and passing the refrigerant.

20. The cooling system of claim 19, wherein:
the first heat dissipation unit and the second heat dissipation unit are integrally configured, and an expansion valve is provided on a refrigerant line connected to the at least one chiller.

21. The cooling system of claim 19, wherein:
the coolant passing through the first heat dissipation unit is supplied to the battery module along the second coolant line, and
the coolant passing through the second heat dissipation unit is supplied to the autonomous driving controller along the coolant connection line.

22. The cooling system of claim 12, wherein:
the first radiator and the second radiator are formed in an integrated form partitioned to prevent the first and second coolant from being mixed.
